(19) United States
(12) Patent Application Publication
(10) Pub. No.: US 2014/0189055 A1
(43) Pub. Date: Jul. 3, 2014

(54) MIGRATION OF USAGE SESSIONS BETWEEN DEVICES

(71) Applicant: Uniloc USA, Inc., Plano, TX (US)

(72) Inventor: Craig S. Etchegoyen, Plano, TX (US)

(73) Assignee: Uniloc Luxembourg S.A., Luxembourg (LU)

(21) Appl. No.: 14/050,213

(22) Filed: Oct. 9, 2013

Related U.S. Application Data
(60) Provisional application No. 61/747,574, filed on Dec. 31, 2012.

(30) Foreign Application Priority Data
Mar. 1, 2013 (AU) 2013100259

(51) Int. Cl. H04L 29/08

(52) U.S. Cl. CPC H04L 67/148
USPC 709/217

(57) ABSTRACT

A user's session with a computing device can be migrated to any of a number of devices under the user's control. By allowing the user to migrate this session between devices in the user's device-sphere, much of the seamlessness of the user's experience in cloud computing is provided in a distributed device-sphere. The session is saved on a first device, sent to a second device, and reconstructed on the second device. A session record includes data, such as URIs, identifying the multiple open files of the session; data identifying the applications within which the files were open; and GUI positions of the windows of each of the open files.

This application claims priority to U.S. Provisional Application No. 61/747,574, filed Dec. 31, 2012, which is fully incorporated herein by reference.

### BACKGROUND OF THE INVENTION

1. Field of the Invention

The present invention relates generally to computer networks and, more particularly, to methods of and systems for improving inter-device data transport efficiency.

2. Description of the Related Art

Not too many years ago, an individual might use only one or two computing devices—perhaps one at work and perhaps one at home. Today, individuals use a wide variety of computing devices. For example, it is not at all uncommon for an individual to have multiple computers at work, at home (perhaps a desktop computer and a laptop computer), a smart phone (which includes a pocket-sized, fully functional computer), digital cameras (still and video), and perhaps one or more tablet computers. In addition, many household appliances in use today also incorporate fully functional computers. Such appliances include televisions, set-top boxes, personal video recorders (PVRs), digital media players, and networked music players.

The multitude of devices used by an individual can be thought as the individual's device-sphere. One of the challenges associated with an individual's device-sphere is that the device-sphere is hardly seamless. An individual may which to view a video captured in a video camera on a television. Such typically requires a cabled connection between the two and separate control of each, despite the fact that both are fully capable of communication with one another through a computer network. Similar examples include wanting to watch a movie purchased and downloaded through a computer on the television, wanting to view photos taken with a digital still camera or smart phone's camera on a tablet computer or a work computer to share the photos with guests. Many, many other examples can be imagined in which data on one device in the device-sphere is desired to be accessible from another device in the device-sphere.

Many predict that more and more of an individual's data will be stored in a “cloud”, i.e., in a remotely located server in a wide area network, which is typically drawn in block diagrams as a cloud. By storing all of one's data in the cloud, all of that individual's devices would have equal access to the data. Many resources have been, and continue to be, devoted to creating and improving the cloud in which all such data is to be stored.

However, not everybody is eagerly rushing to migrate all their data to the cloud. One major concern is that of security of the data stored outside an individual's device-sphere. Photos in an individual's digital camera or smart phone appear to be secure as long as the individual retains physical possession of the camera and the phone. However, the same photos in the cloud are accessible to numerous employees of the entity providing the cloud service, e.g., information technology employees, data maintenance employees, and user support employees. In addition, instances of security failures regarding servers and services of large, well-known and trusted companies make headlines all too often.

Perhaps an even more significant reason for the lack of a massive migration to cloud storage of everybody's personal data is simple convenience. Long gone are the days when someone crafting computer-implemented products and services could assume technological sophistication of the user base. For example, it is simply expected that using a smart phone to make telephone calls, send text messages, browse the web, take photos and video, store and listen to music, and even use the LED flash for photographs as a flashlight to be immediately intuitive and simple. And yet, it seems that producers of such smart phones have succeeded amazingly well in achieving that and similar goals for usability.

However, when one produces a smart phone, the particulars of the cloud with which the smart phone should be configured to coordinate data migration is not known. So, any such integration is left to the user of the smart phone. Since the smart phone is meant to be an exceedingly easy to use appliance, most smart phone users either don't know how or don't want to configure smart phones after purchase to coordinate data migration with a cloud.

Some smart phones are produced with cloud synchronization built-in. For example, the Android mobile operating system produced by Google, Inc. integrates well with cloud-based services provided by Google, Inc. A user of Android can have all photos captured by the smart phone automatically uploaded to the Google+ social networking service provided by Google, Inc. Similarly, the Windows 7 Mobile operating system provided by Microsoft Corp. integrates well with cloud-based services provided by Microsoft Corp.

Yet, there is still hesitation by many to agree to automated synchronization of all user data to the cloud. For example, perhaps not all photos captured on a smart phone are suitable for automatic uploading to a social networking site, even if the photos remain private in the site until the user specifies otherwise.

Whether out of security concerns, privacy concerns, or complexity in configuring interfaces between computing devices and cloud services, a user's personal data remains distributed across many devices operated by the user. In addition, it seems that this will continue to be the case for the foreseeable future.

What is needed is a way to improve inter-device communication to facilitate a user's access to data distributed throughout the user's device-sphere.

### SUMMARY OF THE INVENTION

In accordance with the present invention, a user's session with a computing device can be migrated to any of a number of devices under the user's control. Any modern operating system includes a system of windows, each of which can be associated with a user space application processing a data file. The user can have multiple windows, and multiple associated data files, open and active within a session at one time. By allowing the user to migrate this session between devices in the user's device-sphere, much of the seamlessness of the user's experience in cloud computing is provided in a distributed device-sphere.

To migrate a session from one device to another, the session is saved on the first device, sent to the second device, and reconstructed on the second device.

The first device saves the session in a session record that includes data, such as URIs, identifying the multiple open files of the session. The session record can also include data identifying the applications within which the files were open and GUI positions of the windows of each of the open files.

The first device sends the session record to the second device by broadcasting the session record to all devices of the user's device-sphere and/or by storing the session record in a predetermined location known to all devices in the device-sphere. Broadcasting the session record risks that no device connected to the network at the time the first device broadcasts the session record is connected to the network when the second device attempts to retrieve the session record. Storing the session record at a predetermined location requires that (i) at least one device in the device-sphere is always connected or (ii) a device outside the device-sphere be used as the predetermined location. Using both techniques in combination improves availability of the session record to the second device.

The second device retrieves the session record by broadcasting a request for the session record to all devices of the user's device-sphere and/or by retrieving the session record from the predetermined location known to all devices in the device-sphere.

The second device launches applications to open each of the data files represented in the session record and positions the launched applications in windows at approximate positions corresponding to the GUI positions of each data file represented in the session record.

The end result is that the user's session on one device in her device-sphere is migrated to another device in her device-sphere.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a number of devices that cooperate to migrate a user session from one device to another in accordance with one embodiment of the present invention.

FIG. 2 is a block diagram showing an example of a user session that can be migrated in accordance with one embodiment of the present invention.

FIG. 3 is a logic flow diagram showing the saving of a session in accordance with one embodiment of the present invention.

FIG. 4 is a logic flow diagram showing the restoring of a session in accordance with one embodiment of the present invention.

FIG. 5 is a transaction diagram illustrating one embodiment according to the invention of a method by which two devices of FIG. 1 cooperate to open data files represented by URIs in the session record.

FIG. 6 is a block diagram showing a session record that represents a usage session to be migrated between devices.

FIG. 7 is a block diagram of MIME-type associations that can be used to ensure that a data file represented by a URI can be properly processed by the recipient device.

FIG. 8 is a block diagram showing one of the devices of FIG. 1 in greater detail.

### DETAILED DESCRIPTION

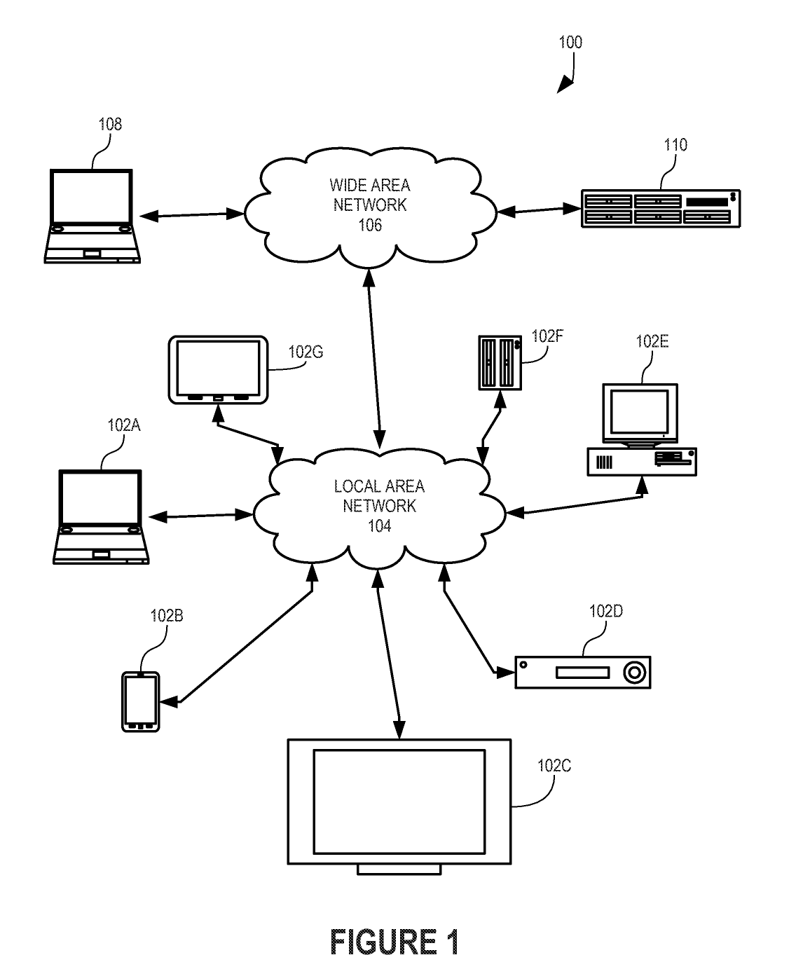

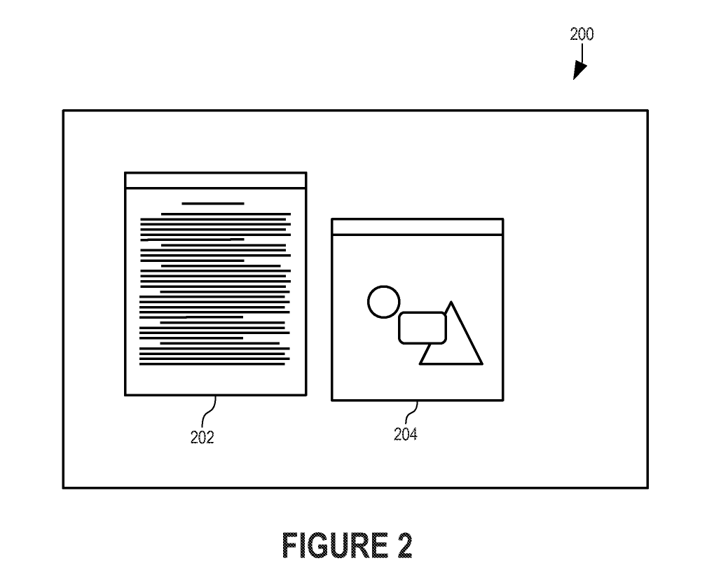

In accordance with the present invention, devices 102A-G (FIG. 1) of an individual's device-sphere cooperate to migrate a user's session from any of devices 102A-G and 108 to any other of devices 102A-G and 108. FIG. 2 shows a simple session involving two applications 202 and 204 on a computer desktop 200. In this illustrative example, computer desktop 200 is to be migrated from device 102E to device 102A. The user has been working on device 102E, using application 202 (FIG. 2) to edit a text document and application 204 to edit a drawing, and now wishes to continue work using device 102A using the same applications to edit the same data files.

In this illustrative example, the user's device-sphere includes devices 102A G, device 108, and server 110. Devices 102A-G are coupled to one another through a local area network (LAN) 104, which can be owned and operated by the individual user in her home. There are a wide variety of computing devices that can be included in one's device-sphere; the devices shown in FIG. 1 are merely illustrative. Device 102A is a laptop computer. Device 102B is a smart phone. Device 102C is a modern, networked television. Device 102D is a networked PVR (Personal Video Recorder).

Device 102E is a desktop computer. Device 102F is a NAS (Network-Attached Storage) appliance. Device 102G is a tablet computer.

Device 108 is remotely located, being connected to LAN 104 though a wide area network (WAN) 106. In this illustrative embodiment, device 108 connects to LAN 104 through WAN 106 through a Virtual Private Network (VPN) connection. In this illustrative embodiment, WAN 106 is the Internet.

Server 110 is also connected to LAN 104 though WAN 106. Server 110 provides cloud services to the individual user through any of devices 102A-G and 108. Such cloud services can include e-mail, photo and video hosting and sharing, document editing and hosting, social networking, calendaring, and music streaming, for example.

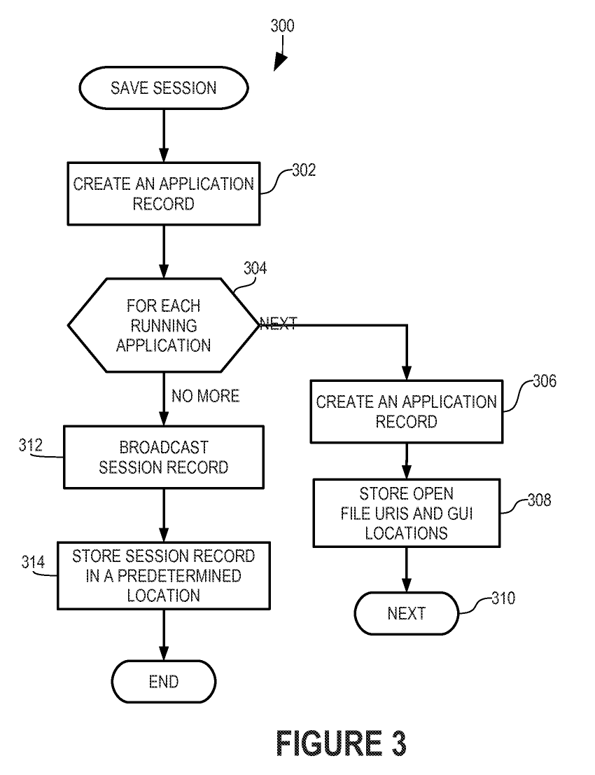

To migrate session 200 (FIG. 2) from device 102E to device 102A, device 102E first saves data representing session 200 in the manner illustrated by logic flow diagram 300 (FIG. 3). The saving of session 200 can be triggered by a request of the user through physical manipulation of one or more user input devices and known GUI techniques or can be triggered automatically during shut-down of device 102E

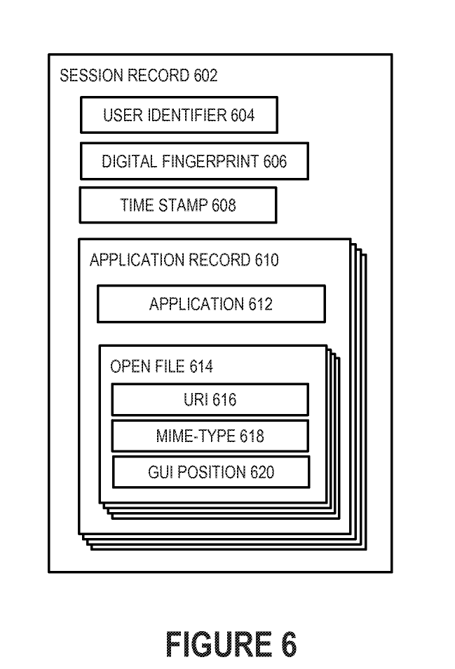

In step 302, device 102E creates a session record such as session record 602 (FIG. 6) to represent session 200 (FIG. 2). User identifier 604 specifies the user name under which the current user is logged in within device 102E. Digital fingerprint 606 is a globally unique identifier of device 102E. Digital fingerprints offer the advantage of being more stable and less amenable to spoofing that are IP addresses and MAC addresses. Digital fingerprints are known and described in U.S. Patent Application Publication 2011/0093503 for “Computer Hardware Identity Tracking Using Characteristic Parameter-Derived Data” by Craig S. Etchegoyen (filed Apr. 21, 2011) and that description is incorporated herein in its entirety by reference. Time stamp 608 specifies the current time and date and the creation time and date of session record 602.

Loop step 304 (FIG. 3) and next step 310 define a loop in which device 102E processes each of the user-space applications currently in use in session 200 according to steps 306 and 308. During each iteration of the loop of steps 304-310, the particular application processed by device 102E is sometimes referred to as the subject application in the context of logic flow diagram 300.

In step 306, device 102E creates an application record such as application record 610 (FIG. 6) for the current application. Application 612 identifies the subject application. In some embodiments, application 612 is omitted and associations within device 102A for MIME (Multipurpose Internet Mail Extensions) types, more recently referred to as Internet media types.

In step 308 (FIG. 3), device 102E stores URI (uniform resource identifiers) and GUI (graphical user interface) locations for each open file of the subject application. For each open file of the subject application, device 102E creates an open file record 614. URI 616 specifies the location of the open file, including the device on which the open file is stored. MIME-type 618 specifies a type of data of the open file by MIME type. MIME types include a type and a subtype and can also include a number of additional parameters. For example, a web page in textual HTML has the MIME type of “text/html” wherein the type is “text” and the subtype is “html.” A common additional parameter specifies the particular character set of the web page. GUI position 620 specifies the location and size of the window in session 200 (FIG. 2) of the open file of the subject application, including the relative depth of the window so as to indicate the which windows occlude other windows.

From step 308 (FIG. 3), processing by device 102E transfers through next step 310 to loop step 304 to process the next application according to the loop of steps 304-310. When all applications of session 200 have been processed, session record 602 (FIG. 6) represents all open files and GUI locations of windows within session 200 (FIG. 2) and processing by device 102E transfers to step 312 (FIG. 3).

In step 312, device 102E broadcasts session record 602 (FIG. 6) to all devices in the user's device-sphere, i.e., to devices A-G (excluding itself) and device 108. In step 314, device 102E stores session record 602 in a location known to all devices in the user's device sphere. Such a location can be in server 110 or device 102F, which is a NAS appliance, at a predetermined URL. Steps 312 and 314 seem redundant; however, step 312 avoids reliance on an external server for managing one's own device-sphere and step 314 provides backup for the situation in which none of the other devices of the user's device-sphere are powered on or at least connected to a network.

In alternative embodiments, the user can specify—through physical manipulation of one or more user input devices and known GUI techniques—the device within her device-sphere to which session record 602 should be sent. In these alternative embodiments, session record 602 can be sent by e-mail to device 102A such that device 102A can receive session record 602 whenever device 102A is powered up and connected to the network. After step 314, processing according to logic flow diagram 300 completes.

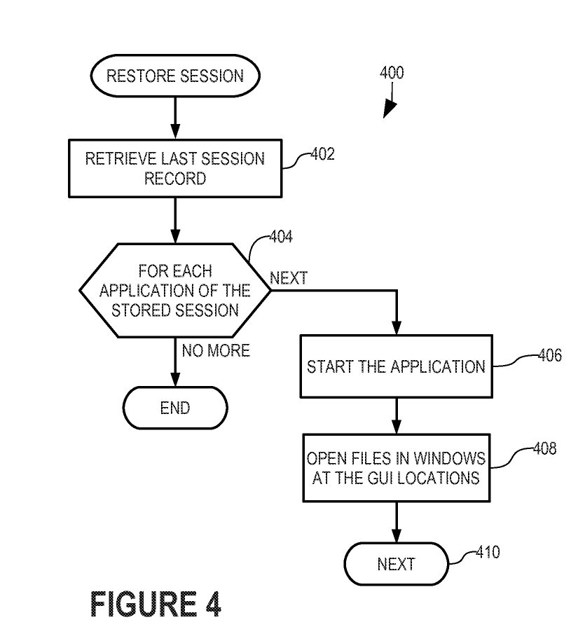

To complete migration of session 200 (FIG. 2) from device 102E to device 102A, device 102A uses the data representing session 200 to replication session 200 in the manner illustrated by logic flow diagram 400 (FIG. 4). Session restoration can be triggered automatically at start-up or can be requested by the user.

In step 402, device 102A retrieves the most recent of session records 602 (FIG. 6) for which user identifier 604 specifies the user name under which the current user is logged in within device 102A. Time stamp 608 is used by device 102A to determine which of session records is the most recent.

Device 102A collects session records 602 by broadcasting a request for session records for the current user to all devices in the user's device-sphere and by retrieving a session record from the predetermined URL at which session records are stored for the subject user and her device-sphere.

In an embodiment in which session record 602 is sent directly to device 102A by direction from the user, an e-mail address for device 102A is associated with session saving and restoration and the e-mail address is checked by device 102A in step 402 (FIG. 4) to retrieve the session record.

Loop step 404 (FIG. 4) and next step 410 define a loop in which device 102A processes each of the application records 610 of the session record according to step 406 and 408. During each iteration of the loop of steps 404-410, the particular application record processed by device 102A is sometimes referred to as the subject application record in the context of logic flow diagram 400.

In step 406, device 102A launches an application identified by application 612 of the subject application record. As described above, application 612 is omitted and associations within device 102A for MIME types in some embodiments. In such embodiments, session record 602 includes only open file records 614, and device 102A skips step 406.

In step 408 (FIG. 4), device 102A processes all open file records 614 (FIG. 6) to send URI 616 and GUI position 620 to cause the application to open the file identified by URI 616 in a window located at GUI position 620. In embodiments in which application 612 is omitted, device 102A uses MIME-type 618 to determine an application predetermined to be the one to process the data file type specified in MIME-type 618 within the operating system of device 102A and launches an instance of that application, providing URI 616 and GUI position 620. The result is that a new window opens in a session on device 102A in which the data file identified by URI 616 at a location specified by GUI position 620 for an application qualified to process the data file.

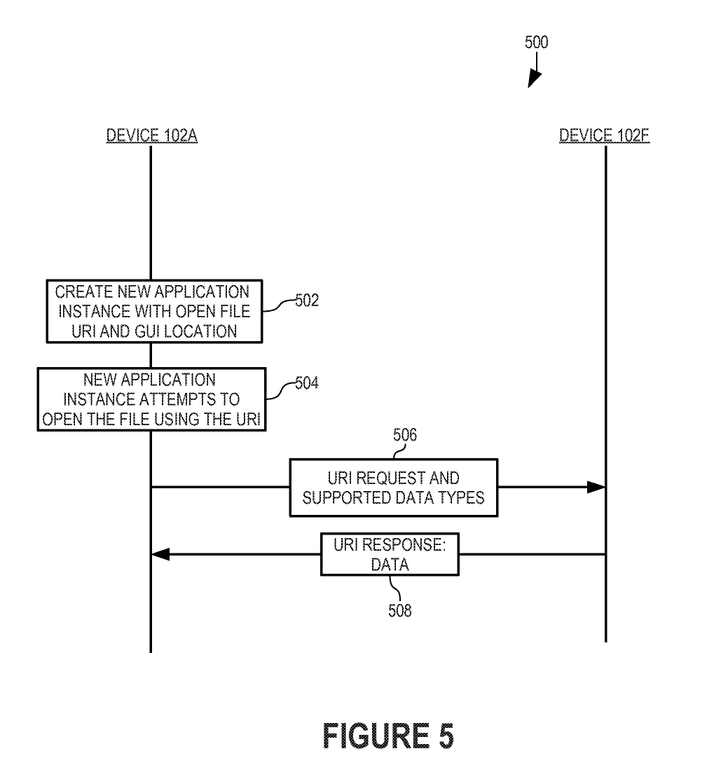

This process is illustrated by transaction flow diagram 500 (FIG. 5). In this illustrative example, URI 616 of the subject open file indicates that the file is stored on device 102F. It should be observed that the open file can be stored on any device at any location that can be specified by URI 616.

In step 502, device 102A launches a new application instance using URI 616 and GUI position 620 in the manner described above with respect to step 408 (FIG. 4). Devices 102A-G and 108 can vary widely in display dimensions and display resolutions. Accordingly, GUI positions within the display of each device are approximated and scaled to accommodate opening of multiple windows given each devices display size. In addition, some device, such as smart phones, have such small displays that each new window can use the entire screen in some embodiments.

In step 504 (FIG. 5), the newly launched application instance attempts to open the data file identified by the URI.

In attempting to open the data file, device 102A sends a request in step 506 to the device specified in the URI, e.g., device 102F in this illustrative example. Along with the request, device 102A sends a list of MIME types that device 102A is capable of handling. For some of the MIME types, device 102A has applications capable of properly processing that MIME type. For other MIME types, device 102A is capable of converting a data file from that MIME type to one that device 102A is capable of processing properly.

In step 508, device 102F sends responsive data representing the data file identified by the URI received in step 506 in a MIME type data format that device 102A supports as indicated by the MIME types specified in the request of step 506. If the requested data file is not in any of the MIME types supported by device 102A, device 102F converts the data file to a MIME type that is supported by device 102A if device 102F has the capacity to do so and denies the request otherwise. In some embodiments, device 102F or device 102A can determine that the ability to edit the data file in the MIME type received should not be edited. Such can be the case if the received MIME type cannot handle formatting or features of the original format or if device 102A has no editing applications for the received MIME type. In either case, the data file will be opened in a “read only” mode on device 102A.

From step 408 (FIG. 4), processing by device 102A transfers through next step 410 to loop step 404 to process the next application record according to the loop of steps 404-410. When all applications records of session record 602 have been processed, session 200 (FIG. 2) will have been restored on device 102A and processing by device 102A of logic flow diagram 400 (FIG. 4) completes.

Opening a file in step 408 includes using the URI of the file to retrieve the file from a device in the user's device-sphere and is illustrated in transaction flow diagram 500 (FIG. 5). In step 502, device 102A creates a new instance of the application and, in step 504, the new application instance attempts to open the file using the URI. The retrieval of the file specified by the URI is handled by the operating system of device 102A, using a device identifier portion of the URI to identify the particular device within which the file is stored. In this illustrative example, the URI identifies device 102F as the device on which the file is stored. Accordingly, device 102A sends the URI request to device 102F in step 506.

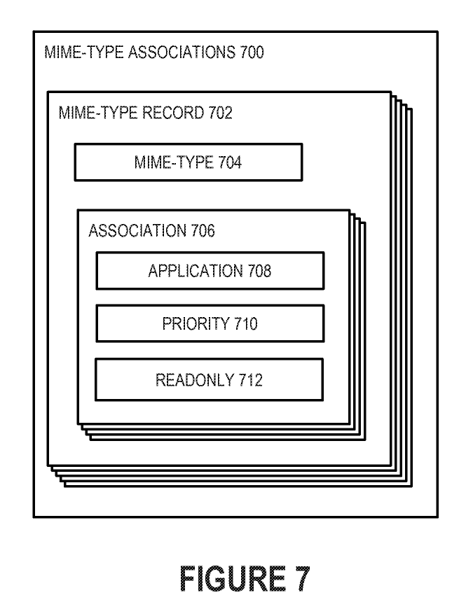

In addition to the URI request, device 102A sends data representing all MIME types that device 102A can process. Device 102A determines which MIME types it can process by reference to MIME-type associations 700 (FIG. 7).

MIME-type associations 700 includes a number of MIME-type records 702, each of which represents associations for a given MIME-type, which is identified by MIME-type 704. Each MIME-type record 702 includes a number of associations 706, which represent an application within device 102A that can process data files of the given MIME-type. Application 708 identifies the application. Priority 710 specifies a relative priority among all associations 706 of a given MIME-type record 702. Read only 712 indicates whether (i) the application specified by application 708 can process the file in a manner in which the user can modify the file or (ii) the application and only display the file. The application identified by application 708 can be merely a conversion application that converts data files of the type specified by MIME-type 704 to another type.

Upon receipt of the URI and MIME types supported by device 102A in step 506 (FIG. 5), device 102F uses the URI to locate the data file identified by the URI and compares the MIME type of the data file to the MIME types supported by 102A. If the MIME type of the data file is not one supported by device 102A, device 102F uses its own set of MIME-type associations 700 to determine whether device 102F can convert the requested data file to a MIME type that device 102A can process.

In step 508, device 102F sends the data file, as converted if converted, to device 102A as the response to the URI request. Device 102A performs transaction flow diagram 500 for each URI to be opened.

The end result is that session 200 is saved from device 102E and restored to device 102A. The user can thereafter continue editing the word processing document of window 202 and the drawing of window 204.

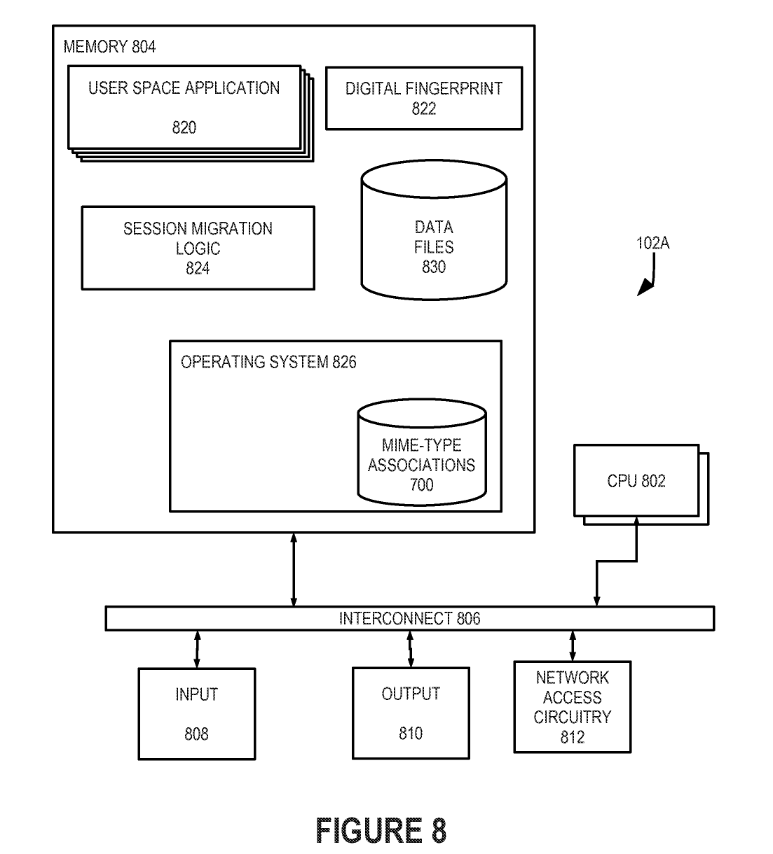

Device 102A is shown in greater detail in FIG. 8, which is equally representative of devices 102B-G and 108 unless otherwise noted here. Device 102A includes one or more microprocessors 802 (collectively referred to as CPU 802) that retrieve data and/or instructions from memory 804 and execute retrieved instructions in a conventional manner. Memory 804 can include generally any computer-readable medium including, for example, persistent memory such as magnetic and/or optical disks, ROM, and PROM and volatile memory such as RAM. As used herein, “computer-readable medium” excludes any transitory signals but includes any non-transitory data storage circuitry, e.g., buffers, cache, and queues, within transceivers of transitory signals.

CPU 802 and memory 804 are connected to one another through a conventional interconnect 806, which is a bus in this illustrative embodiment and which connects CPU 802 and memory 804 to one or more input devices 808, output devices 810, and network access circuitry 812. Input devices 808 can include, for example, a keyboard, a keypad, a touch-sensitive screen, a mouse, a microphone, and one or more cameras. Output devices 810 can include, for example, a display—such as a liquid crystal display (LCD)—and one or more loudspeakers. Network access circuitry 812 sends and receives data through computer networks such as LAN 104 (FIG. 1).

A number of components of device 102A are stored in memory 804. In particular, user space applications 820, session migration logic 824 logic, and operating system 826 are each all or part of one or more computer processes executing within CPU 802 from memory 804 in this illustrative embodiment but can also be implemented using digital logic circuitry. As used herein, “logic” refers to (i) logic implemented as computer instructions and/or data within one or more computer processes and/or (ii) logic implemented in electronic circuitry.

User space applications 820 are applications the user can use to view or edit data files. Session migration logic 824 saves and restores sessions in the manner described above.

Operating system 826 is the operating system of device 102A. An operating system is logic implemented in a computing device that provides services used by other logic implemented in the computing device. The services typically include management of computer resources such as file systems, peripheral device support, networking services, and computer process management. Generally, most users don't directly use an operating system but rather use logic that in turn uses the operating system to perform various tasks. Examples of operating systems in use today include Linux, Unix, MacOS, and various incarnations of the Windows operating system.

In this illustrative embodiment, operating system 826 optimizes data traffic among devices 102A-G and 108 in the manner described in co-pending, commonly owned U.S. Patent Application 61/770,662 filed Feb. 28, 2013, by Craig S. Etchegoyen for “Device-Specific Content Delivery” and that description is incorporated herein by reference.

Digital fingerprint 822, data files 830, and MIME-type associations 700 are data stored persistently in memory 804. Digital fingerprint 822 includes data specific to hardware elements of device 102A, such as serial numbers and parameters of hardware components of device 102A, to serve as a globally unique identifier of device 102A. Data files 830 includes one or more data files that the user might want to view or edit using any of user space applications 820 on any of devices 102A-G and 108. MIME-type associations 700 are described above.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for migrating a user session from a first device to a second device, the method comprising:
in the first device, saving a session record representing the user session wherein the session record includes data representing one or more data files that are open within the user session;
in the first device, sending the session record to the second device;
in the second device, receiving the session record from the first device;
in the second device, opening the one or more data files represented in the session record by launching one or more user space applications, to thereby reconstruct the user session in the second device;
wherein the session record also includes data representating a graphical user interface position within the user session of at least one of the data files that are open within the user session.

2. The method of claim 1 wherein sending the session record to the second device comprises storing the session record at a predetermined location; and
further wherein receiving the session record from the first device comprises retrieving the session record from a predetermined location.

3. The method of claim 1 wherein the first and second devices belong to a collection of devices under the control of a single user;
further wherein sending the session record to the second device comprises broadcasting the session record to devices that belong to the collection of devices; and
further wherein receiving the session record from the first device comprises broadcast a request for the session record to devices that belong to the collection of devices.

4. The method of claim 1 wherein the session record also includes data representing a user space application in use within the user session.

5. A non-transitory computer readable medium useful in association with a first device which includes one or more processors and a memory, the computer readable medium including computer instructions which are configured to cause the client device, by executed of the computer instructions in the one or more processors from the memory, to migrate a user session from a first device to a second device by at least:
in the first device, saving a session record representing the user session;
wherein the session record includes data representing one or more data files that are open within the user session;
in the first device, sending the session record to the second device;
in the second device, receiving the session record from the first device;
in the second device, opening the one or more data files represented in the session record by launching one or more user space applications, to thereby reconstruct the user session in the second device;
wherein the session record also includes data representing a graphical user interface position within the user session of at least one of the data files that are open within the user session.
